(19) United States
(12) Patent Application Publication
(10) Pub. No.: US 2008/0086869 A1
(43) Pub. Date: Apr. 17, 2008

(54) Plastic molded motor housing

(76) Inventor: Luis E. Acosta, Lawrenceville, GA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/987,483

(22) Filed: Nov. 30, 2007

Related U.S. Application Data
(62) Division of application No. 11/236,345, filed on Sep. 27, 2005.
(60) Provisional application No. 60/615,529, filed on Oct. 1, 2004.

(51) Int. Cl. H02K 15/14

(52) U.S. Cl. 29/596; 264/238

(57) ABSTRACT

A housing assembly 30 is provided for a permanent magnet motor. The housing assembly includes a ferrous flux ring structure 38 having an exterior 39 and an interior 36. Magnet structure 34 is carried within the interior of the flux ring structure 38. A plastic housing 32 substantially encapsulates the exterior of the flux ring structure 38 and at least portions of the magnet structure 34. A bearing 42 may be provided in a closed end of the housing 32.

This application is based on U.S. Provisional Application No. 60/615,529 filed on Oct. 1, 2004, and claims the benefit thereof for priority purposes.

### FIELD OF THE INVENTION

The invention relates to a housing for a permanent magnet motor and, more particularly, to a motor housing molded from plastic material.

### BACKGROUND OF THE INVENTION

With reference to FIGS. 1a and 1b, a conventional motor housing assembly has many components, including a metal motor housing 10, permanent magnets 12 mounted in the housing 10, magnet retainers 14 for maintaining the magnets in the housing, a thrust bearing spacer 16, a bearing 18, and a bearing retainer 20.

There is a need to integrate a number of above-mentioned individual component functions into a simplified configuration thus, reducing the overall part count of a motor assembly. There is also a need to reduce noise by improving the geometry around the magnets of the motor, for example, by eliminating surface discontinuities.

### SUMMARY OF THE INVENTION

An object of the present invention is to fulfill the need referred to above. In accordance with the principles of the present invention, this objective is obtained by providing a housing assembly for a permanent magnet motor. The housing assembly includes a ferrous flux ring structure having an exterior and an interior. Magnet structure is carried within the interior of the flux ring structure. A plastic housing substantially encapsulates the exterior of the flux ring structure and at least portions of the magnet structure.

In accordance with another aspect of the invention, a method of providing a motor housing assembly provides a ferrous flux ring structure having an exterior and interior. Magnet structure is mounted in the interior of the flux ring structure, and plastic material is provided substantially over the exterior of the flux ring structure and at least portions of the magnet structure, to define a housing.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification.

### BRIEF DESCRIPTION OF THE DRAWINGS

The invention will be better understood from the following detailed description of the preferred embodiments thereof, taken in conjunction with the accompanying drawings, wherein like reference numerals refer to like parts, in which:

FIG. 1a is front exploded view of a conventional motor housing assembly.

FIG. 1b is rear exploded view of the conventional motor housing assembly of FIG. 1a.

FIG. 2a is a rear view of the motor housing assembly provided in accordance with the principles of the present invention.

FIG. 2b is a front view of the motor housing assembly of FIG. 2a.

FIG. 3a is front exploded view of the motor housing assembly of FIG. 2b.

FIG. 3b is a rear exploded view of a motor housing assembly of FIG. 2a

FIG. 4 is a sectional view of the motor housing assembly provided in accordance with the principles of the present invention.

FIG. 5 is a sectional view taken along the line 5-5 in FIG. 4.

FIG. 6 is a sectional view taken along the line 6-6 in FIG. 4.

FIG. 7 is a view of the bearing disposed in the plastic housing and showing bearing retaining structure in accordance with an embodiment of the invention.

### DETAILED DESCRIPTION OF THE EXEMPLARY EMBODIMENT

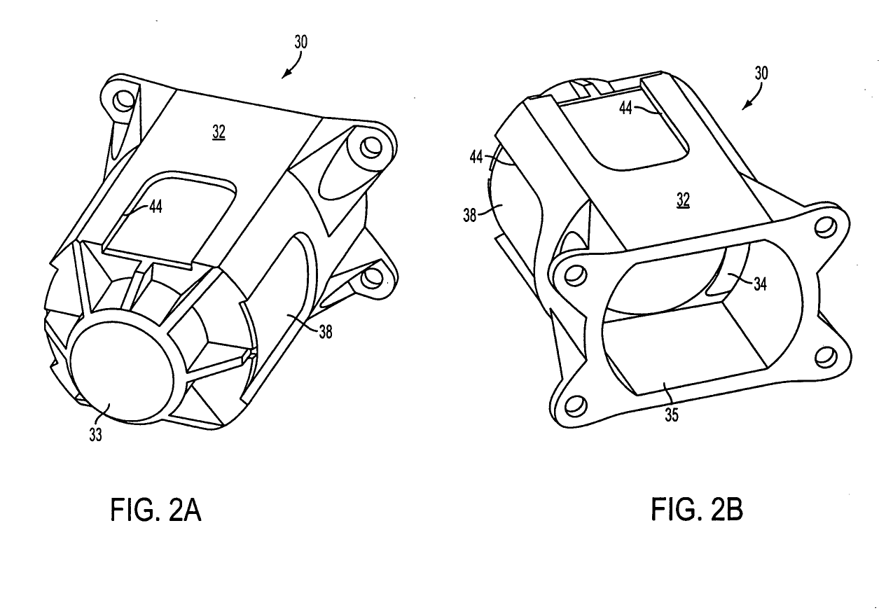

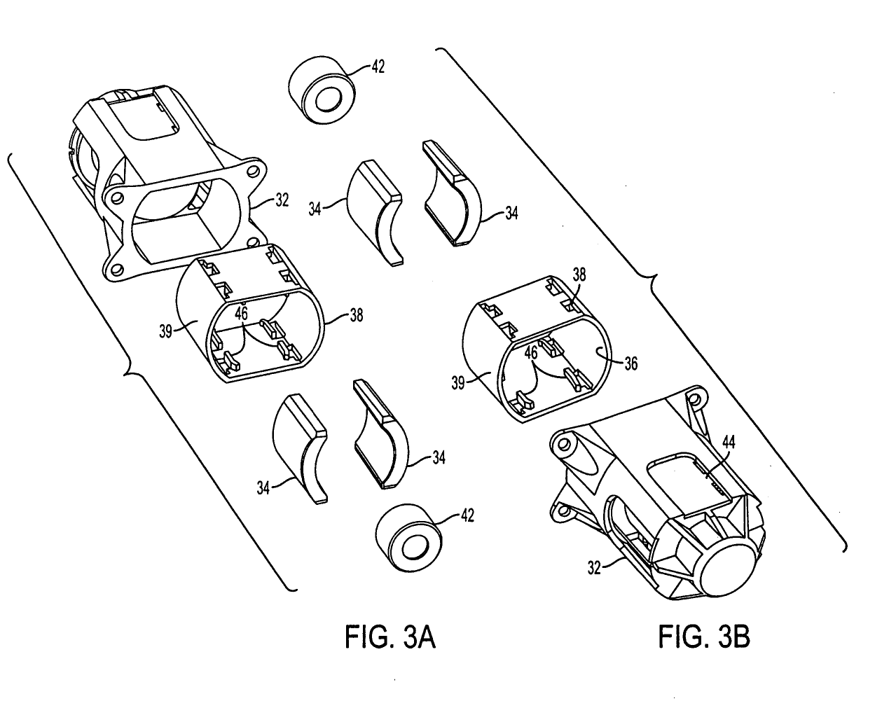

With reference to FIGS. 2a and 2b, a motor housing assembly is shown, generally indicated at 30, in accordance with the principles of the present invention. FIGS. 2a and 2b shown the housing assembly 30 in an assembled condition and FIGS. 3a and 3b are exploded views of the housing assembly 30. As best shown in FIGS. 3a and 3b, the housing assembly 30 includes a plastic motor housing 32. The housing 32 preferably includes a closed end 33 and an open end 35. A pair of permanent magnets 34 are pressed into an interior 36 of a steel (ferrous) flux ring 38. The flux ring 38 with magnets 34 therein is provided in an interior 40 of the housing 32. More particular, the exterior 39 of the flux ring 38, with magnets therein, is preferably substantially encapsulated by the plastic housing 32.

With reference to FIGS. 5 and 6, the housing assembly 30 also includes a bearing 42, preferably of plastic, such as a PTFE based resin, that is disposed in the closed end 33 of the plastic housing 32. The bearing 42 is pressed into the plastic housing 32 or molded therein using a dual shot molding machine. The bearing 42 is constructed and arranged to support an end of a shaft (not shown) of an armature assembly (not shown) that is received in the housing 32 to define a motor. The bearing 42 could also be a sintered bearing.

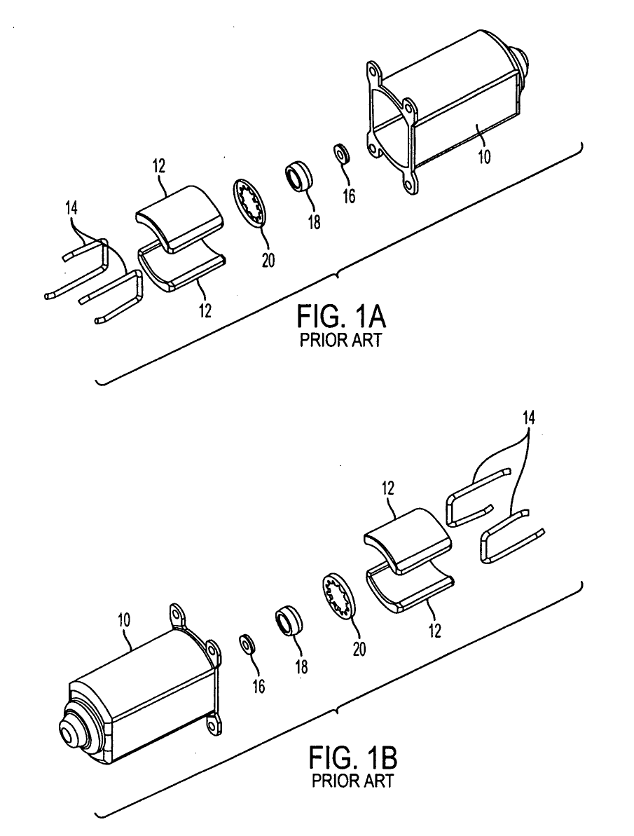

Thus, it can be appreciated that the housing assembly 30 eliminates the need for the conventional two magnet retainers 14, the bearing retainer 20 and the thrust bearing or end spacer 16 of FIGS. 1a and 1b. Electromagnetic Compatibility (EMC) concerns may be addressed by using “conductive” plastics for shielding or by using special conductive coatings. Exposed metal portions of the flux ring 38, due to openings 44 provided in the sides of the housing 32, are intended for heat dissipation.

The conventional metal motor housing 10 has been reduced to a flux ring 38, which incorporates cut and bent tabs 46 (FIGS. 3a and 3b) that engage the magnets 34, securing the magnets 34 to the flux ring 38. The ferrous flux ring 38 can be manufactured from either from tubular or flat stock (rolled with dovetail lock). As noted above, the flux ring 38 and magnet subassembly is substantially encapsulated in plastic material of the housing 32. The plastic housing 32 can be molded as a separate part and then the flux ring and magnet subassembly can be inserted (e.g., pressed) into the housing, or plastic material can be molded over the flux ring and magnet subassembly to define the housing 32.

The bearing 42 can be molded as a separate component and pressed into the housing 32 or can be molded in a dual shot process just after the plastic motor housing 32 is molded. The bearing 42 incorporates the thrust bearing function in the event that the motor housing material is found not to be adequate.

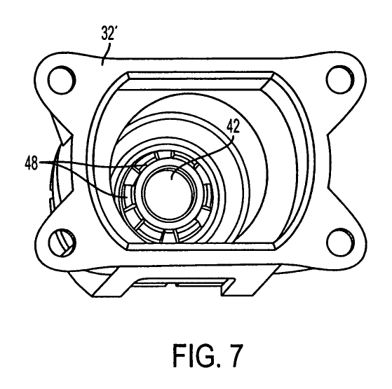

FIG. 7 shows another embodiment of the plastic housing 32′. The self-aligning bearing 42 is disposed in the housing 32′ and is retained therein by bearing retaining structure 48 that is integrally molded into the plastic structure 32′. The retaining structure 48 may be in the form of flexible projections or tabs that can hold the bearing 42 in place. Thus, no separate bearing retaining ring is required.

Although all disclosed embodiments of the housing 32, 32′ show the end near the bearing to be closed, it can be appreciated that the end of the housing 32, 32′ can include a bore that cooperates with the bore of the bearing 42 so that a shaft supported by the bearing 42 can extend from the housing 32, 32′. Furthermore, the bearing 42 can be eliminated when the housing 32 includes surfaces defining a bearing bore that is greased to support a shaft for rotation.

In general, the housing assembly 32, 32′ can be employed in any application involving the use of electric motors. The housing assembly 32, 32′ is configured with automotive windowlift applications in mind. The desired effects of the use of the housing assembly 32, 32′ are:

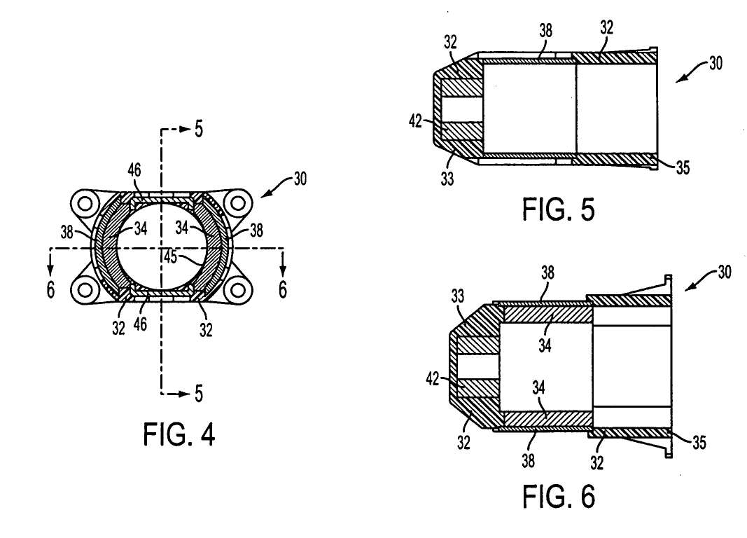

1) Reduced overall subassembly costs, 2) Simplified product configuration, 3) Reduction of motor noise due the encapsulation of magnets by the housing 32, 32′ into a continuous annular surface 45 (no surface discontinuities that can induce noise due to turbulent air flow while the motor is running, see FIG. 4).

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the spirit of the following claims.

1-16. (canceled)

17. A method of providing a motor housing assembly, the method including:
providing a ferrous flux ring structure having an exterior and interior,
mounting magnet structure in the interior of the flux ring structure, and
providing plastic material substantially over the exterior of the flux ring structure and at least portions of the magnet structure, to define a housing.

18. The method of claim 17, wherein the plastic material is molded over at least a substantial portion of the flux ring structure and the portions of the magnet structure.

19. The method of claim 17, wherein the flux ring structure is pressed into an interior of the housing.

20. The method of claim 17, wherein the step of defining the housing includes providing the housing to include a closed end and an open end, the method further includes providing a bearing in the closed end of the housing.

21. The method of claim 17, wherein the bearing and the housing are molded, with the bearing being molded from plastic in a dual shot process after the housing is molded.

22. The method of claim 17, wherein the bearing is pressed into engagement with the housing.

23. The method of claim 17, wherein the interior of the flux ring structure includes tabs, the mounting step including engaging the magnet structure with the tabs.

24. The method of claim 20, wherein the plastic housing includes bearing retaining structure molded therein, the method including retaining the bearing to the plastic housing via the bearing retaining structure.

25. The method of claim 17, wherein the step of providing the plastic material includes defining a continuous annular surface by the housing and the magnet means.
